(19) United States
(12) Patent Application Publication
(10) Pub. No.: US 2026/0205644 A1
(43) Pub. Date: Jul. 16, 2026

(54) VIRTUAL USER IDENTIFICATION USING PROXY-LABELED SESSION PAIR DISCRIMINATION

(71) Applicant: Netflix, Inc., Los Gatos, CA (US)

(72) Inventors: Patric Glynn, Bellevue, WA (US); Athiya Deviyani, Pittsburgh, PA (US); Cheng Ju, Sunnyvale, CA (US); Kevin John Zielnicki, San Francisco, CA (US)

(21) Appl. No.: 19/436,375

(22) Filed: Dec. 30, 2025

Related U.S. Application Data
(60) Provisional application No. 63/743,822, filed on Jan. 10, 2025.

(51) Int. Cl. H04N 21/25; A63F 13/86; H04N 21/24

(52) U.S. Cl. CPC H04N 21/251; A63F 13/86; H04N 21/24

(57) ABSTRACT

A computer-implemented method includes receiving, as training data, streaming session data for a user profile in a streaming service, designating continue-watching behavior across a session pair of the user profile as a positive proxy signal, indicating that the same user is watching in both sessions of the session pair, designating concurrent viewing behavior between two or more sessions of the user profile as a negative proxy signal, indicating that different users are watching in the two or more sessions, using the positive and negative proxies to train a model to distinguish between streaming sessions belonging to the same user or between different users of the user profile, and deploying the trained model to infer virtual user identifications within the streaming service. Various other methods, systems, and computer-readable media are also disclosed.

### CROSS REFERENCE TO RELATED APPLICATION

This application claims the benefit of U.S. Provisional Application No. 63/743,822, filed 10 Jan. 2025, the disclosure of which is incorporated, in its entirety, by this reference.

### BACKGROUND

Media streaming services seek to enhance content personalization and accurate audience measurement, yet shared profiles, with limited direct identity signals, complicate “who is watching” within a shared profile at the session level. There is a need for systems that enable reliable session-level user identification using product-generated data.

### SUMMARY

As will be described in greater detail below, the present disclosure describes automated systems and methods for virtual user identification using proxy-labeled session pair discrimination. In one example, a computer-implemented method includes receiving, as training data, streaming session data for a user profile in a streaming service, designating continue-watching behavior across a session pair of the user profile as a positive proxy signal, indicating that the same user is watching in both sessions of the session pair, designating concurrent viewing behavior between two or more sessions of the user profile as a negative proxy signal, indicating that different users are watching in the two or more sessions, using the positive and negative proxies to train a model to distinguish between streaming sessions belonging to the same or different users of the user profile, and deploying the trained model to infer one or more virtual user identifications (e.g., an identification of an inferred user distinct from other inferred users) within the streaming service.

In some examples, designating continue-watching behavior includes detecting, within the streaming session data, the session pair as a session pair with same-title playback, where a second session of the session pair resumes playback of the same title previously played in a first session of the session pair at a start timestamp that is within a designated time window of the first session's stop timestamp, and labeling the session pair as a positive pair based on the detected continue-watching resumption. In one example, designating concurrent viewing behavior between the two or more sessions of the user profile as a negative proxy signal includes detecting, within the streaming session data, an additional session pair with playback of different titles during overlapping time intervals under the user profile and labeling the additional session pair as a negative pair based on the detected concurrent viewing.

In some examples, the method further includes constructing session features from the streaming session data to use as inputs to train the model, the constructed session features including device indicators, location indicators, time features, content features, user interaction features, and/or recommendation context features. In some examples, features that are directly derived from continue-watching behavior or concurrent viewing behavior are excluded from the constructed session features. In some examples, the method further includes training the model with a contrastive objective that reduces a distance between positive session pairs and increases a distance between negative session pairs and/or training the model by enforcing a minimum separation margin for negative session pairs such that negative session pairs with a distance below the margin incur an increased loss.

In some examples, during training, the model is configured to increase a weight applied to negative session pairs relative to positive session pairs in a loss function or dynamically adjust positive and negative weights per training batch based on observed counts of positive and negative session pairs (e.g., by setting, for each batch, a positive weight and a negative weight as functions of the counts of negative and positive session pairs in the batch, respectively, to maintain balanced learning). In some examples, the method further includes training the model by selecting hard negative session pairs having an embedding distance below a margin and increasing a sampling rate and/or a loss weight for the selected hard negative session pairs. In some examples, deploying the model to infer one or more virtual user identifications within the streaming service includes, for each user profile within a plurality of user profiles, grouping streaming sessions into a plurality of virtual users based on distances between session-level embeddings.

In some aspects, the techniques described herein relate to a system including one or more processors and physical memory including computer-executable instructions that, when executed by a physical processor, cause the physical processor to receive, as training data, streaming session data for a user profile in a streaming service, designate continue-watching behavior between a pair of sessions of the user profile as a positive proxy signal, indicating that the same user is watching in both sessions of the pair, designate concurrent viewing behavior between two or more sessions of the user profile as a negative proxy signal, indicating that different users are watching in the two or more sessions, use the positive and negative proxies to train a model to distinguish between streaming sessions belonging to the same or different users of the user profile, and deploy the trained model to infer one or more virtual user identifications (e.g., identifications of inferred users distinct from other inferred users) within the streaming service.

In some aspects, the techniques described herein relate to a non-transitory computer-readable medium including one or more computer-executable instructions that, when executed by at least one processor of a computing device, cause the computing device to receive, as training data, streaming session data for a user profile in a streaming service, designate continue-watching behavior between a pair of sessions of the user profile as a positive proxy signal, indicating that the same user is watching in both sessions in the pair, designate concurrent viewing behavior between two or more sessions of the user profile as a negative proxy signal, indicating that different users are watching in the two or more sessions, use the positive and negative proxies to train a model to distinguish between streaming sessions belonging to the same or different users of the user profile, and deploy the trained model to infer one or more virtual user identifications (e.g., identifications of inferred users distinct from other inferred users) within the streaming service.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for virtual user identification using proxy-labeled session pair discrimination.

FIG. 2 is a block diagram of an exemplary system for virtual user identification using proxy-labeled session pair discrimination.

FIG. 3A is a flow diagram of an exemplary training flow for virtual user identification using proxy-labeled session pair discrimination.

FIG. 3B is a flow diagram of a deployment flow for virtual user identification using a model trained with proxy-labeled session pair discrimination.

FIG. 4A is a block diagram of a session pair with continue-watching behavior.

FIG. 4B is a block diagram of a session pair with concurrent streaming behavior.

FIG. 5 is a block diagram of an exemplary content distribution ecosystem.

FIG. 6 is a block diagram of an exemplary distribution infrastructure within the content distribution ecosystem shown in FIG. 5.

FIG. 7 is a block diagram of an exemplary content player within the content distribution ecosystem shown in FIG. 5.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Streaming services face a significant challenge in accurately distinguishing between different users of shared profiles. Conventional systems assume a one-to-one mapping between profiles and users, but surveys indicate that up to 40% of profiles are shared among multiple users, leading to “profile pollution.” This misalignment results in degraded personalization, inaccurate audience measurement, and suboptimal user experiences across streaming, gaming, and interactive content.

There are several fundamental obstacles to constructing a model that accurately distinguishes between separate users of a profile across streaming sessions. One such obstacle is that training high-quality models typically depends on labeled ground truth, yet obtaining reliable ground truth about user identity is extremely difficult, even at the coarse profile level. Users rarely explicitly indicate when they are sharing profiles or watching content together. Traditional approaches rely on explicit user switching or device fingerprinting for ground truth. However, explicit switching creates friction in the user experience while failing to capture organic viewing patterns, and device fingerprinting alone cannot handle shared devices or distinguish between users of the same device. Another obstacle is the multi-faceted nature of modern streaming, spanning passive viewing, interactive gaming, and live events. Each domain brings its own behavioral patterns and technical constraints, with applications requiring identity information at vastly different granularities and latencies (e.g., with some applications operating at a profile/account level with daily/weekly updates and other applications demanding session-level user identification, such as for real-time personalization). Yet another obstacle is class imbalance and label noise in training data, where there are far more “same-user” examples than “different-user” examples.

The disclosed framework addresses the lack of reliable ground truth by utilizing implicit behavioral signals, such as “continue-watching” and “concurrent streaming,” as proxy signals for ground truth. As these terms are used within this paper, “continue watching” refers to resuming playback of a same title in a later session at approximately the prior session's stop timestamp (e.g., within a designated time window), while “concurrent streaming” refers to playback of different titles during overlapping time intervals under the same profile (e.g., on different devices). Within session data for a user profile, session pairs with continue-watching resumption are pseudo-labeled as positive (same user), and session pairs with concurrent streaming of different titles are pseudo-labeled as negative (different users). A model can then be trained with the pseudo-labeled session pairs to separate streaming sessions by behavior similarity. This enables the model to distinguish between distinct users of a user profile without requiring explicit labels during training. To handle noisy, imbalanced data, the disclosed framework incorporates a session-level embedding architecture in which embeddings are trained using a max-margin contrastive loss function. This pulls positive session pairs closer together while pushing negative pairs apart, enabling the model to learn meaningful representations of user behavior, even in scenarios with significant class imbalance. The model can be any type of artificial intelligence or machine learning model, including a sequence-to-sequence encoder such as a long short-term memory (LSTM) network, a transformer-based encoder with reduced depth and heads, or a feedforward network configured to produce session-level embeddings for contrastive training.

Additionally, the framework relies on stabilizing elements for training robustness, such as hard negative pairs, dynamically reweights loss by batch composition, and employs a compact encoder (e.g., a 3-layer LSTM) to further stabilize training under extreme class imbalance. The resulting session embedding space is unified and reusable, enabling real-time, session-level attribution and batch aggregation for audience measurement without retraining separate models for different latency and granularity requirements. This approach allows streaming services to deliver more precise personalization, enhance audience measurement, and adjust to diverse user behaviors without requiring explicit identity labels.

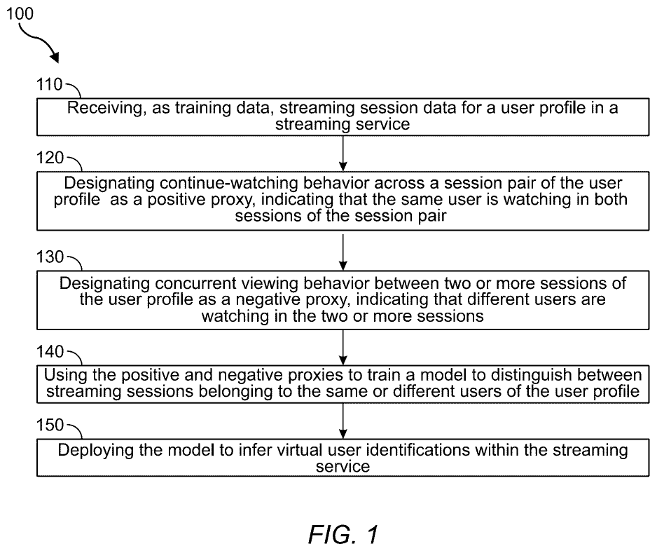

The following will provide, with reference to FIGS. 1-7, detailed descriptions of exemplary embodiments and drawing elements for virtual user identification using proxy-labeled session pair discrimination.

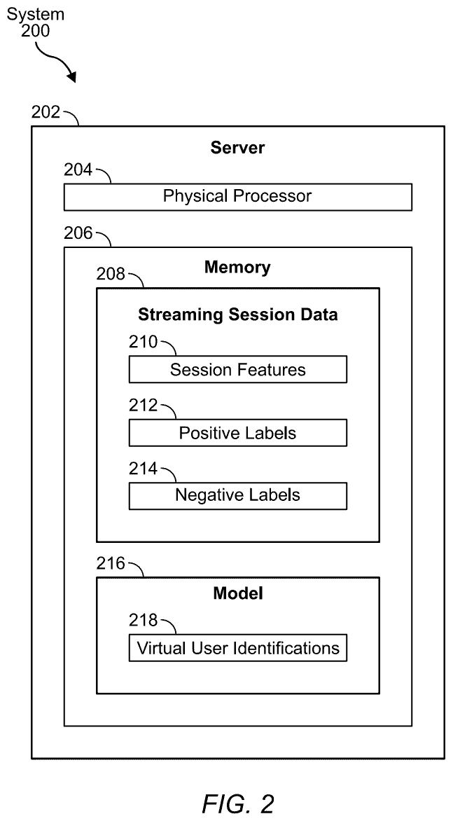

FIG. 1 is a flow diagram of an exemplary computer-implemented method 100 for virtual user identification using proxy-labeled session pair discrimination. The steps shown in FIG. 1 may be performed by any suitable computer-executable code and/or computing system, including the system(s) illustrated in FIG. 2. In some examples, the steps shown in FIG. 1 may be performed by modules operating within a computing device. For example, the steps shown in FIG. 1 may be performed by modules operating in a server 202 (e.g., a backend computing device). In one example, one or more of the steps shown in FIG. 1 may represent an algorithm whose structure includes and/or is represented by multiple sub-steps, examples of which will be provided in greater detail below. The modules and computer-executable instructions for performing the steps of method 100 may be executed by a physical processor 204 and stored in memory 206, as illustrated in system 200 of FIG. 2.

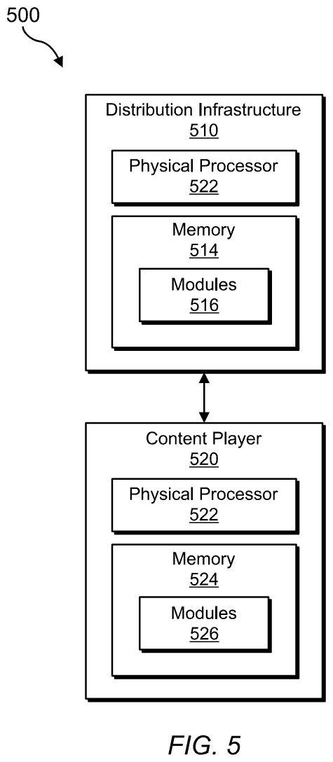

Server 202 may represent any type or form of hardware-based and/or software-based system configured to host, process, store, and/or deliver digital content to end users via a networked interface. In some examples, server 202 may represent, or operate as part of, a content distribution ecosystem (e.g., such as the content distribution ecosystem that will be described in greater detail below in connection with FIGS. 5-7), such as a streaming media service, in which streaming content is delivered to users via profiles as part of user streaming sessions. Server 202 can be implemented as a single server, a distributed cluster of servers, or a cloud-hosted service spanning multiple regions. In some deployments, training services and serving (inference) services may be hosted on different servers or clusters, with trained parameters transferred from a training environment to a serving environment.

Turning now to FIG. 1, at step 110 one or more of the systems described herein receive, as training data, streaming session data for a user profile in a streaming service. For example, as illustrated in FIG. 2, server 202 receives, as training data, streaming session data 208.

The term “streaming session” refers to a period of user activity with a streaming service, associated with a user profile, from login to logout and/or from the start of interaction until inactivity for a designated timeout. Streaming session data 208 refers to the behavioral footprint of streaming sessions at the profile level. As a general matter, this data reflects what content (e.g., which media title) was played and when, on which device and from which location, together with navigation and feedback interactions that occurred before or during playback. For example, streaming session data 208 may include, for a given streaming session, playback start/stop timestamps, title identifiers, device type and usage history, country or network indicators, impression and playback counts, search and detail views, and thumbs or add-to-list actions recorded within the session timeline.

The term “user profile” refers to an identifier used by a streaming service to associate sessions, settings, and content interactions with a logical identity on an account. Generally, a user profile is associated with a particular viewer (e.g., configured with a profile name or image selected by the viewer) or with a household. While conventional systems may assume a one-to-one mapping between a profile and a single user, in practice one profile can be used by multiple distinct viewers, with distinct content preferences and distinct behaviors (e.g., discovery habits or engagement patterns) interleaved across the streaming sessions of the profile. Co-viewing further changes the viewing behavior associated with a profile (e.g., a viewer may choose different content when watching alone than when watching with children or a spouse). All of this can result in many mixed behavioral signals tied to a single profile identifier. These mixed behavioral signals dilute personalization and complicate audience measurement.

One response to these kinds of mixed signals is to train a model that distinguishes between different viewers within a shared profile, producing “virtual users” that capture person-level patterns. Virtual users enable attribution at the session level while preserving privacy, as they represent distinct behavior clusters rather than named individuals tied to real-world identities. Training such a model is difficult because this type of training typically depends on ground truth (i.e., verified reference labels known to be correct). In this context, the ground truth of interest would be a trusted label that states whether two sessions (i.e., a session pair) belong to the same person or different people. In streaming contexts, ground truth is scarce. In the present context, ground truth cannot be explicitly extracted from streaming session data 208 (e.g., because viewers rarely declare “who is watching”).

Another difficulty is that in practice, most session pairs in streaming session data 208 will point to the same person (e.g., up to 90%), creating an extreme imbalance within streaming session data 208. In simple terms, there are many “same person” pairs and far fewer “different people” pairs within streaming session data 208. This skew within streaming session data 208 can make a model trained on the data overly confident that every streaming session corresponds to the same person. Responses to both of these difficulties will be discussed later in connection with steps 120-140.

After receiving streaming session data 208, server 202 forms session pairs from the sessions represented within the data. A “session pair” refers to two distinct streaming sessions associated with the same user profile that are compared for identity attribution. Server 202 can form session pairs using any type of per-profile metric (e.g., a time-based proximity metric or an activity-based cue). In some examples, pairing is driven by proxy signals (e.g., the proxy signals that will be described in connection with steps 120 and 130). As a general matter, the session pairs, which will be used for supervision and later inference, are constructed only from sessions tied to a single profile identifier, avoiding cross-profile mixing that could distort attribution. As a specific example, which will be described later, continue-watching and concurrent viewing detections are applied to sessions of the same profile to create labeled pairs, and downstream grouping into virtual users is computed per profile rather than across profiles.

In addition to forming session pairs, server 202 transforms streaming session data 208 into session features 210. Session features 210 refer to a fixed-format representation of each streaming session that captures stable behavioral signals suitable for model input. Server 202 constructs session features 210 by standardizing raw events and metadata into structured indicators of stable behavioral signals such as device and location indicators, time features, content representations, and interaction context. For example, device and location can be encoded into robust indicators, counts can be binned to tame extremes, and content can be represented via embeddings that reflect substantive viewing. In some examples, device and location usage frequency is encoded as “primary” or “secondary” to standardize indicators across profiles and reduce reliance on unique identifiers. Content features can weight title embeddings by watch duration so that titles watched longer contribute more to the session representation, with a minimum viewing threshold applied to avoid brief or accidental starts. To enable generalization and avoid shortcut learning, features that directly reflect proxy detections (e.g., continue-watching resumption or concurrent viewing) are excluded from session features 210. This feature schema is applied both in training (as will be described in connection with step 140) and in production (as will be described in connection with step 150), ensuring alignment between the training path and the serving path.

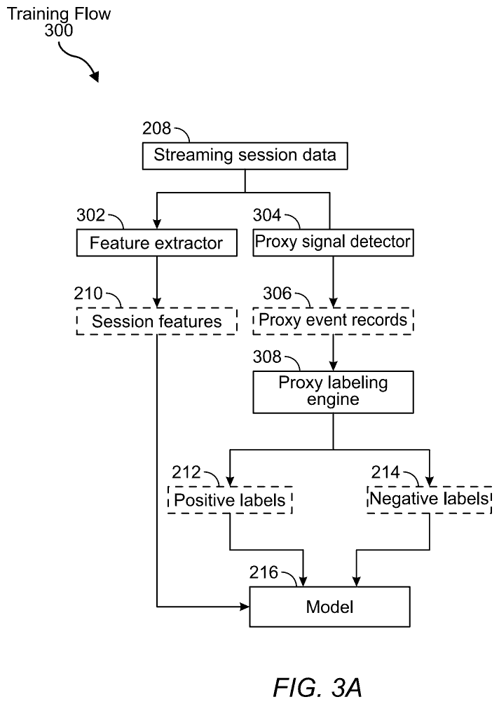

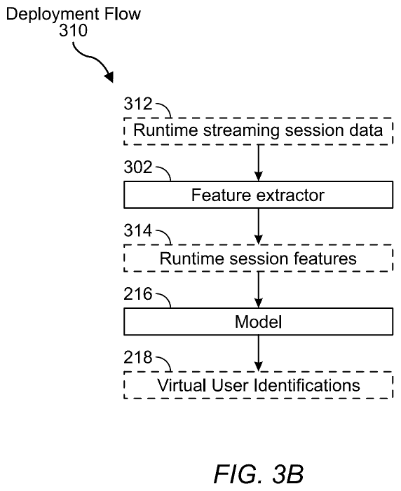

FIG. 3A provides a training flow 300 corresponding to the steps of FIG. 1, showing how streaming session data 208 is used in training and FIG. 3B provides a deployment flow 310 corresponding to the steps of FIG. 1, showing how runtime streaming session data 312 is used in deployment, as will be described later. As shown in FIG. 3A, a feature extractor 302 constructs session features 210 from streaming session data 208 and provides the fixed-format inputs used in both training (step 140) and deployment (step 150).

Returning to FIG. 1, at step 120 one or more of the systems described herein designate continue-watching behavior across a session pair of the user profile as a positive proxy (i.e., positive proxy signal), indicating that the same user is watching in both sessions of the session pair. For example, as illustrated in FIG. 2, server 202 designates continue-watching behavior across a session pair, detected within streaming session data 208, as a positive proxy signal indicating that the same user is watching in both sessions of the session pair.

Proxy signals provide training supervision as stand-ins for ground truth. In the disclosed system, a positive proxy signal indicates “same user” and a negative proxy signal indicates “different users,” and each detected proxy produces a positive or negative training label for a corresponding session pair used only during training. A “label” is the target answer a model learns from (e.g., same user vs different users), whereas a “feature” is an input attribute derived from session data (e.g., device type, time of day, title embedding) that the model uses to make its prediction. A variety of product-generated signals can act as positive proxy signals. One such signal is “continue-watching” behavior. In this context, “continue-watching” refers to same-title playback behavior within a session pair where a second session of the session pair resumes playback of a same media title previously played in a first session of the session pair at a start timestamp that is within a designated time window of the first session's stop timestamp. As a specific example, if a viewer watches 30 minutes of a movie at 2:00 PM and later resumes the same movie at approximately the 30-minute mark at 8:00 PM under the same profile, the disclosed system treats this session behavior as a positive proxy signal indicating the same person and labels the pair of streaming sessions with a positive label (i.e., “same user”). These proxy signals serve as substitutes for direct identity labels, enabling the model to learn person-level patterns without tying sessions to real-world identities.

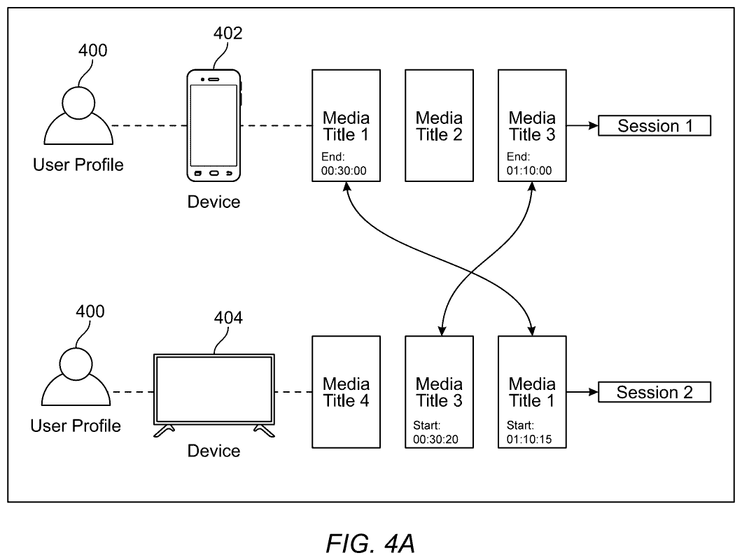

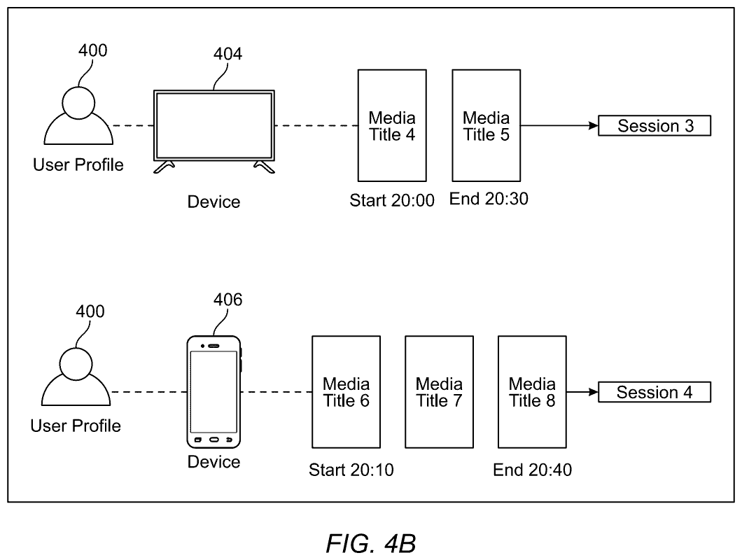

FIG. 4A illustrates “continue-watching” behavior across a pair of sessions (session 1 and 2 of a user profile 400). The top row in FIG. 4A corresponds to a first session in a session pair and the bottom row corresponds to a second session in the session pair. In the first session a user, streaming content under user profile 400, streams “Media Title 1,” followed by “Media Title 2,” followed by “Media Title 3” on a device 402. As shown in FIG. 4A, the user stops “Media Title 1” at timestamp 00:30:00 and stops “Media Title 3” at timestamp 01:10:00. Then, in the second session, a user, streaming content under user profile 400 on a device 404, streams “Media Title 4,” followed by “Media Title 3,” followed by “Media Title 1.” In this second session, “Media Title 3” resumes at timestamp 01:10:15 and “Media Title 1” resumes at timestamp 00:30:20, each within a designated time window (e.g., ±60 seconds) of the prior stop timestamp. In this exemplary illustration, resumption of “Media Title 1” and “Media Title 3” at approximately the prior stop timestamp within a designated time window would be treated as a positive proxy signal.

Server 202 can detect continue-watching behavior using any rule-based detection logic applied to per-profile playback events. In some examples, detection operates within a playback control structure by evaluating start and stop timestamps and title identifiers for two sessions of the same profile, and identifying a title-resumption when the second session begins the same title near the first session's stop timestamp within a designated time window stored in memory. Turning to FIG. 3A as a specific example of a proxy detection and labeling pipeline, a proxy signal detector 304 analyzes streaming session data 208 to identify candidate continue-watching events and emits proxy event records 306. Proxy event records 306 include identifiers and detection metadata for each session pair selected as a proxy signal (for both positive proxies, as described at this step and negative proxies, as will be described at step 130). For a positive proxy signal, such identifiers and detection metadata can include session-pair identifiers, a profile identifier, a title identifier, and measured timestamp information (e.g., prior stop timestamp and resume start timestamp with computed offset). The proxy event records are then provided to the proxy labeling engine 308, which will assign positive labels 212 to the corresponding session pairs. In some examples, detection applies a minimum watch-time threshold (e.g., two minutes) so that brief plays, trailers, or accidental starts are excluded from continue-watching consideration.

Continue-watching behavior is a strong positive proxy because viewers typically resume their own content rather than picking up someone else's progress, and resuming at approximately the same timestamp provides a clear, repeatable signal of continuity across sessions. This intuition is supported by validation against survey-derived data in which continue-watching detections were compared to survey responses that indicate whether the same person watched specific titles within a defined window, making it a survey-based ground truth proxy selected for accuracy.

Returning to FIG. 1, at step 130 one or more of the systems described herein designate concurrent (e.g., co-incident) viewing behavior between two or more sessions of the user profile as a negative proxy signal, indicating that different users are watching in the respective sessions. For example, as illustrated in FIG. 2, server 202 designates concurrent viewing across an additional session pair, detected within streaming session data 208, as a negative proxy signal indicating different users for the sessions of the session pair.

It is worth noting that the absence of a positive proxy signal does not imply a negative proxy signal. Negatives require their own detection criteria. For example, session pairs are not labeled “different users” simply because they lack continue-watching behavior. Instead, negative labels are assigned only when a clear “different people” signal is detected, such as concurrent viewing of different titles during overlapping intervals under the same profile.

Server 202 can detect concurrent viewing using any rule-based detection logic applied to per-profile playback events. In some examples, detection operates within the playback control structure by evaluating playback start and stop timestamps and title identifiers for two sessions of the same profile, and identifying an overlap when the two sessions play different titles during a designated overlap interval stored in memory (e.g., on different devices).

FIG. 4B illustrates “concurrent viewing” behavior across another pair of streaming sessions associated with user profile 400. The top row in FIG. 4B corresponds to a first session (session 3) in this session pair and the bottom row corresponds to a second session (session 4) in the pair, each corresponding to the same user profile 400. The top row shows “Media Title 4” and “Media Title 5” with playback from Start 20:00 to End 20:30, while the bottom row shows “Media Title 6,” “Media Title 7,” and “Media Title 8” with playback from Start 20:10 to End 20:40. The first session is played on device 404 and the second session is played on a device 406. In this exemplary illustration, the overlapping interval (20:10-20:30) under the same user profile 400 would be treated as a negative proxy signal. For clarity, the times in FIG. 4A refer to in-title timestamps (e.g., playhead positions), whereas the times in FIG. 4B refer to session-level clock times for playback intervals. In some examples, detection applies a minimum overlap duration (e.g., at least one minute) and a minimum active playback duration for each session to avoid transient overlaps or brief starts from being treated as negative proxies.

Turning again to FIG. 3A to illustrate how step 130 fits into an overall training flow, proxy signal detector 304 analyzes streaming session data 208 to identify candidate concurrent viewing events and emits, within proxy event records 306, identifiers and detection metadata for each of the identified session pairs, such as session-pair identifiers, a profile identifier, title identifiers for different titles, and measured overlap information (e.g., overlap start and end timestamps). The proxy event records for these session pairs are then provided to the proxy labeling engine 308, which assigns negative labels 214 to the corresponding session pairs.

Returning to FIG. 1, at step 140 one or more of the systems described herein use the positive and negative proxies to train a model to distinguish between streaming sessions belonging to the same user or between different users of the user profile. For example, as illustrated in FIG. 2, server 202 uses positive labels 212 and negative labels 214, together with session features 210 constructed from streaming session data 208, to train model 216.

FIG. 3A illustrates how step 140 ties into the disclosed training flow. As mentioned in earlier steps, streaming session data 208 is transformed into session features 210 by feature extractor 302 and is also analyzed by proxy signal detector 304 to produce proxy event records 306, which are then provided to proxy labeling engine 308 to generate positive labels 212 and negative labels 214. As shown in FIG. 3A, these features and labels then converge on model 216, during training, so model 216 learns to separate same-person and different-people session pairs.

In example embodiments, the training process employs a contrastive learning approach that contrasts positively labeled pairs against negatively labeled pairs to learn meaningful session-level representations without requiring direct user labels. As a general approach, embeddings corresponding to sessions from the same user are pulled closer together, and embeddings for sessions from different users are pushed farther apart, creating clear separation in the representation space. For example, using a max-margin contrastive loss, positive pairs minimize distance while negative pairs incur loss when their distance falls below a margin, thereby enforcing a minimum separation. This objective addresses the challenge of scarce ground truth by leveraging proxy-labeled pairs to refine session-level embeddings so that same-user patterns cluster naturally and different-user patterns remain distinct.

In some examples, the model architecture is a sequence-to-sequence encoder that outputs a session-level embedding, and training favors architectural simplicity to ensure stability under noisy, imbalanced supervision. A simpler model, such as a three-layer long short-term memory (LSTM), is selected to capture the contextual nature of profile sessions without added complexity, avoiding embedding collapse observed with more data-hungry architectures under the extreme class imbalance observed in this setting. In practice, reducing heads and layers or selecting a compact LSTM yielded better area under the receiver operating characteristic curve (AUC) and improved separation between positive and negative pair distances, demonstrating that architectural simplification combined with the contrastive objective produces robust session-level embeddings.

In one implementation, training enforces a max-margin constraint for negative pairs so that embeddings for sessions from different users remain separated by at least a minimum separation margin. As a general approach, negative pairs incur loss only when their distance falls below this margin, and the loss increases with the degree of violation, thereby pushing negatives farther apart and maintaining a clear buffer between same-user and different-user sessions. This margin-based separation stabilizes learning under class imbalance by ensuring that scarce negative signals exert sustained influence on the representation space. This directly counteracts the extreme class imbalance discussed throughout the application, because even when positives vastly outnumber negatives, any negative pair that falls inside the margin triggers a stronger correction, ensuring that scarce negative examples continually reshape the embedding space and prevent collapse toward “same user” classifications.

In some examples, the disclosed training process emphasizes hard negative pairs to make learning more efficient and effective. “Hard negative pairs” refers to pairs with the smallest margin violations (meaning their current embedding distance is closest to, or below, a required separation margin as described in the previous paragraph). As a general approach, hard negative pairs are emphasized by (1) selecting negative pairs that are closest in the embedding space (e.g., with distances below or near the margin) and (2) increasing their sampling rate or loss weight during training so model 216 focuses on the most confusable differences. This emphasis improves separation between same-user and different-user sessions because the model learns to correct mistakes in regions of the embedding space where positive and negative pairs overlap or are near the decision boundary, which is where the model is most uncertain, sharpening boundaries and reducing misclassification in challenging cases.

In example embodiments, the disclosed training process applies class weighting so negative pairs have greater influence, despite being fewer in number. “Class weighting” refers to assigning different importance to different label classes in a loss function. In one approach, the loss function assigns a higher weight to negative pairs and a lower weight to positive pairs (e.g., w−>w+), which increases the penalty when different-user sessions are too close and reduces overemphasis on abundant same-user pairs. This weighting counteracts extreme class imbalance by ensuring scarce negative signals shape the embedding space, improving separation between same-user and different-user sessions.

In some examples, weighting is adjusted dynamically per training batch based on observed counts of positive and negative pairs. “Training batch” refers to a set of session pairs processed together during one optimization step of the training process. As a general approach, the system computes batch-specific weights (e.g., set the positive weight proportional to the number of negatives in the batch and the negative weight proportional to the number of positives, with a small smoothing term) so whichever class is rarer in that batch receives more emphasis. This dynamic reweighting adapts to shifting data slices and maintains balanced learning, preventing the model from drifting toward majority patterns when batch composition varies over time.

As a general approach, features used during training are selected to emphasize stable signals and tame extremes. Impression and playback counts are binned to handle long-tail values, content is represented via title embeddings weighted by watch duration so substantive viewing contributes relatively more, and a minimum viewing time can be applied to exclude brief or accidental starts. These feature notes ensure the model learns from meaningful patterns rather than outliers or noise. The disclosed system maintains train/serve consistency so model 216 sees the same kind of inputs in production as it did during training. As a general approach, the same fixed-format session feature schema is constructed from runtime streaming session data and provided to the trained model for inference, while proxy-derived labels are used only during training and are not present at deployment.

Returning to FIG. 1, at step 150 one or more of the systems described herein deploy the trained model to infer virtual user identifications within the streaming service. For example, as illustrated in FIG. 2, server 202 deploys trained model 216 to infer virtual user identifications 218 within the disclosed streaming service. As used in this paper, “virtual user identification” refers to an inferred association of streaming sessions of a user profile to a single inferred viewer, distinct from other inferred viewers of the same user profile.

FIG. 3B illustrates a deployment flow 310 in which runtime streaming session data 312 is transformed by feature extractor 302 into runtime session features 314 and provided to trained model 216 to generate virtual user identifications 218. As a general approach, the same fixed-format feature schema used in training is applied at runtime, proxy-derived labels are not generated or consumed, and downstream logic groups sessions of the user profile into virtual user identifications 218 by evaluating distances between session-level embeddings (e.g., thresholding or clustering) without requiring the proxy signals employed during training.

In some examples, deployment decision logic classifies runtime session pairs as “same user” or “different users” by comparing distances between session-level embeddings to a cutoff. If the distance between two embeddings is below a threshold, the sessions are treated as the same user and if the distance is above the threshold, the sessions are treated as different users. In one example, a per-profile threshold can be selected based on validation metrics. Sessions can also be grouped by clustering embeddings within a profile to form virtual users when pairwise decisions are insufficient.

In some implementations, virtual user identifications 218 are generated across many profiles and rolled up for measurement and reporting. In these implementations, per-profile groupings can be aggregated to estimate distinct viewers, reach, and frequency, supporting audience measurement. In one example, for each user profile within a group of user profiles, sessions are grouped into virtual users based on distances between session-level embeddings, and results are aggregated for downstream analytics.

After training completes and trained parameters are exported, the embeddings or virtual user identifications produced during deployment can be handed off to other servers or services for downstream use. The trained parameters are loaded into a serving environment, inference runs on runtime session features, and outputs are delivered to personalization systems or measurement pipelines, with training and serving hosted on separate infrastructure when desired. This design addresses the differing requirements discussed previously because the same session-level embedding supports both low-latency, per-session personalization and higher-latency, aggregated audience measurement, enabling a unified solution across applications with different timing and granularity needs. In embodiments in which the deployment process runs on a different server, server 202 can deploy the model by exporting trained parameters to a serving cluster, loading model 216 in the serving environment, or providing runtime session features 314 for inference, with outputs forwarded to downstream systems via service interfaces or message queues.

As described above, the disclosed system leverages a contrastive learning paradigm to learn session-level embeddings from behavioral patterns without requiring direct user labels, using product-generated signals like continue-watching resumption and concurrent streaming detection to create proxy-labeled training data. By training with a max-margin contrastive loss that pulls positive pairs together and pushes negative pairs apart (augmented by hard negative mining and class weighting including dynamic reweighting), and a compact encoder (e.g., a three-layer long short-term memory (LSTM) network) to stabilize learning under extreme class imbalance, the resulting embeddings show meaningful separation of user sessions. This unified embedding space supports multiple downstream applications with different timing and granularity needs, enabling real-time personalization and more accurate audience measurement while capturing genuine user patterns without explicit identity labels.

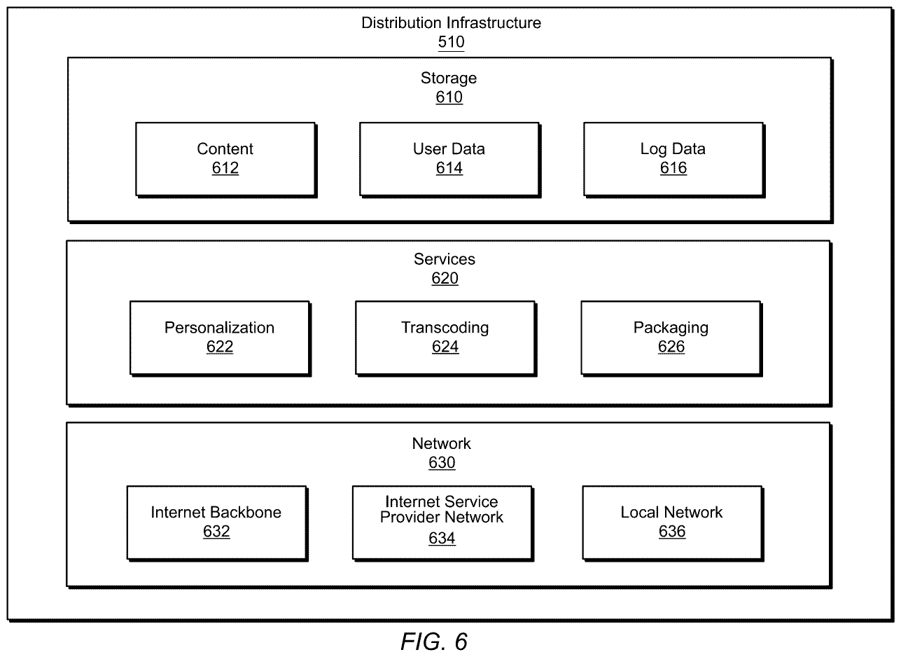

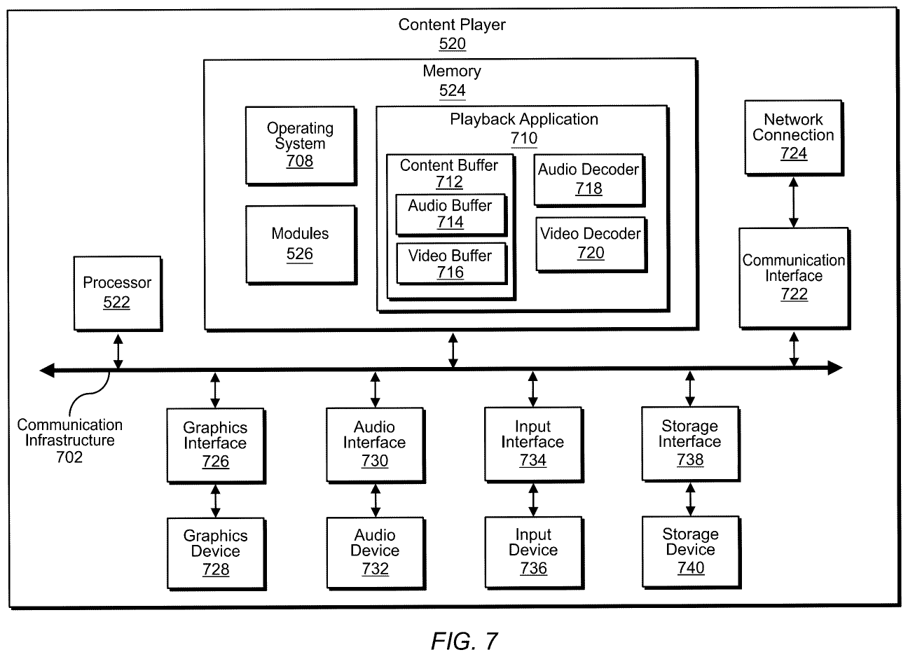

The following will provide, with reference to FIG. 5, detailed descriptions of exemplary ecosystems in which content is provisioned to end nodes and in which requests for content are steered to specific end nodes. The discussion corresponding to FIGS. 6 and 7 presents an overview of an exemplary distribution infrastructure and an exemplary content player used during playback sessions, respectively. These exemplary ecosystems and distribution infrastructures are implemented in any of the embodiments described above with reference to FIGS. 1-7.

FIG. 5 is a block diagram of a content distribution ecosystem 500 that includes a distribution infrastructure 510 in communication with a content player 520. In some embodiments, distribution infrastructure 510 is configured to encode data at a specific data rate and to transfer the encoded data to content player 520. Content player 520 is configured to receive the encoded data via distribution infrastructure 510 and to decode the data for playback to a user. The data provided by distribution infrastructure 510 includes, for example, audio, video, text, images, animations, interactive content, haptic data, virtual or augmented reality data, location data, gaming data, or any other type of data that is provided via streaming.

Distribution infrastructure 510 generally represents any services, hardware, software, or other infrastructure components configured to deliver content to end users. For example, distribution infrastructure 510 includes content aggregation systems, media transcoding and packaging services, network components, and/or a variety of other types of hardware and software. In some cases, distribution infrastructure 510 is implemented as a highly complex distribution system, a single media server or device, or anything in between. In some examples, regardless of size or complexity, distribution infrastructure 510 includes at least one physical processor 522 and at least one memory 514. One or more modules 516 are stored or loaded into memory 514 to enable adaptive streaming, as discussed herein.

Content player 520 generally represents any type or form of device or system capable of playing audio and/or video content that has been provided over distribution infrastructure 510. Examples of content player 520 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 510, content player 520 includes a physical processor 522, memory 524, and one or more modules 526. Some or all of the adaptive streaming processes described herein is performed or enabled by modules 526, and in some examples, modules 516 of distribution infrastructure 510 coordinate with modules 526 of content player 520 to provide adaptive streaming of digital content.

In certain embodiments, one or more of modules 516 and/or 526 in FIG. 5 represent one or more software applications or programs that, when executed by a computing device, cause the computing device to perform one or more tasks. For example, and as will be described in greater detail below, one or more of modules 516 and 526 represent modules stored and configured to run on one or more general-purpose computing devices. One or more of modules 516 and 526 in FIG. 5 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 512 and 522 generally represent any type or form of hardware-implemented processing unit capable of interpreting and/or executing computer-readable instructions. In one example, physical processors 512 and 522 access and/or modify one or more of modules 516 and 526, respectively. Additionally or alternatively, physical processors 512 and 522 execute one or more of modules 516 and 526 to facilitate adaptive streaming of digital content. Examples of physical processors 512 and 522 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 514 and 524 generally represent any type or form of volatile or non-volatile storage device or medium capable of storing data and/or computer-readable instructions. In one example, memory 514 and/or 524 stores, loads, and/or maintains one or more of modules 516 and 526. Examples of memory 514 and/or 524 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 6 is a block diagram of exemplary components of content distribution infrastructure 510 according to certain embodiments. Distribution infrastructure 510 includes storage 610, services 620, and a network 630. Storage 610 generally represents any device, set of devices, and/or systems capable of storing content for delivery to end users. Storage 610 includes a central repository with devices capable of storing terabytes or petabytes of data and/or includes distributed storage systems (e.g., appliances that mirror or cache content at Internet interconnect locations to provide faster access to the mirrored content within certain regions). Storage 610 is also configured in any other suitable manner.

As shown, storage 610 may store a variety of different items including content 612, user data 614, and/or log data 616. Content 612 includes television shows, movies, video games, user-generated content, and/or any other suitable type or form of content. User data 614 includes personally identifiable information (PII), payment information, preference settings, language and accessibility settings, and/or any other information associated with a particular user or content player. Log data 616 includes viewing history information, network throughput information, and/or any other metrics associated with a user's connection to or interactions with distribution infrastructure 510.

Services 620 includes personalization services 622, transcoding services 624, and/or packaging services 626. Personalization services 622 personalize recommendations, content streams, and/or other aspects of a user's experience with distribution infrastructure 510. Transcoding services 624 compress media at different bitrates which, as described in greater detail below, enable real-time switching between different encodings. Packaging services 626 package encoded video before deploying it to a delivery network, such as network 630, for streaming.

Network 630 generally represents any medium or architecture capable of facilitating communication or data transfer. Network 630 facilitates communication or data transfer using wireless and/or wired connections. Examples of network 630 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 6, network 630 includes an Internet backbone 632, an internet service provider 634, and/or a local network 636. As discussed in greater detail below, bandwidth limitations and bottlenecks within one or more of these network segments triggers video and/or audio bit rate adjustments.

FIG. 7 is a block diagram of an exemplary implementation of content player 520 of FIG. 5. Content player 520 generally represents any type or form of computing device capable of reading computer-executable instructions. Content player 520 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 7, in addition to processor 522 and memory 524, content player 520 includes a communication infrastructure 702 and a communication interface 722 coupled to a network connection 724. Content player 720 also includes a graphics interface 726 coupled to a graphics device 728, an input interface 734 coupled to an input device 736, and a storage interface 738 coupled to a storage device 740.

Communication infrastructure 702 generally represents any type or form of infrastructure capable of facilitating communication between one or more components of a computing device. Examples of communication infrastructure 702 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 524 generally represents any type or form of volatile or non-volatile storage device or medium capable of storing data and/or other computer-readable instructions. In some examples, memory 524 stores and/or loads an operating system 708 for execution by processor 522. In one example, operating system 708 includes and/or represents software that manages computer hardware and software resources and/or provides common services to computer programs and/or applications on content player 520.

Operating system 708 performs various system management functions, such as managing hardware components (e.g., graphics interface 726, audio interface 730, input interface 734, and/or storage interface 738). Operating system 708 also provides process and memory management models for playback application 710. The modules of playback application 710 includes, for example, a content buffer 712, an audio decoder 718, and a video decoder 720.

Playback application 710 is configured to retrieve digital content via communication interface 722 and play the digital content through graphics interface 726. Graphics interface 726 is configured to transmit a rendered video signal to graphics device 728. In normal operation, playback application 710 receives a request from a user to play a specific title or specific content. Playback application 710 then identifies one or more encoded video and audio streams associated with the requested title. After playback application 710 has located the encoded streams associated with the requested title, playback application 710 downloads sequence header indices associated with each encoded stream associated with the requested title from distribution infrastructure 510. A sequence header index associated with encoded content includes information related to the encoded sequence of data included in the encoded content.

In one embodiment, playback application 710 begins downloading the content associated with the requested title by downloading sequence data encoded to the lowest audio and/or video playback bitrates to minimize startup time for playback. The requested digital content file is then downloaded into content buffer 712, which is configured to serve as a first-in, first-out queue. In one embodiment, each unit of downloaded data includes a unit of video data or a unit of audio data. As units of video data associated with the requested digital content file are downloaded to the content player 520, the units of video data are pushed into the content buffer 712. Similarly, as units of audio data associated with the requested digital content file are downloaded to the content player 520, the units of audio data are pushed into the content buffer 712. In one embodiment, the units of video data are stored in video buffer 716 within content buffer 712 and the units of audio data are stored in audio buffer 714 of content buffer 712.

A video decoder 720 reads units of video data from video buffer 716 and outputs the units of video data in a sequence of video frames corresponding in duration to the fixed span of playback time. Reading a unit of video data from video buffer 716 effectively de-queues the unit of video data from video buffer 716. The sequence of video frames is then rendered by graphics interface 726 and transmitted to graphics device 728 to be displayed to a user.

An audio decoder 718 reads units of audio data from audio buffer 714 and outputs the units of audio data as a sequence of audio samples, generally synchronized in time with a sequence of decoded video frames. In one embodiment, the sequence of audio samples is transmitted to audio interface 730, which converts the sequence of audio samples into an electrical audio signal. The electrical audio signal is then transmitted to a speaker of audio device 732, which, in response, generates an acoustic output.

In situations where the bandwidth of distribution infrastructure 510 is limited and/or variable, playback application 710 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 726 is configured to generate frames of video data and transmit the frames of video data to graphics device 728. In one embodiment, graphics interface 726 is included as part of an integrated circuit, along with processor 522. Alternatively, graphics interface 726 is configured as a hardware accelerator that is distinct from (i.e., is not integrated within) a chipset that includes processor 522.

Graphics interface 726 generally represents any type or form of device configured to forward images for display on graphics device 728. For example, graphics device 728 is fabricated using liquid crystal display (LCD) technology, cathode-ray technology, and light-emitting diode (LED) display technology (either organic or inorganic). In some embodiments, graphics device 728 also includes a virtual reality display and/or an augmented reality display. Graphics device 728 includes any technically feasible means for generating an image for display. In other words, graphics device 728 generally represents any type or form of device capable of visually displaying information forwarded by graphics interface 726.

As illustrated in FIG. 7, content player 520 also includes at least one input device 736 coupled to communication infrastructure 702 via input interface 734. Input device 736 generally represents any type or form of computing device capable of providing input, either computer or human generated, to content player 520. Examples of input device 736 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 520 also includes a storage device 740 coupled to communication infrastructure 702 via a storage interface 738. Storage device 740 generally represents any type or form of storage device or medium capable of storing data and/or other computer-readable instructions. For example, storage device 740 is a magnetic disk drive, a solid-state drive, an optical disk drive, a flash drive, or the like. Storage interface 738 generally represents any type or form of interface or device for transferring data between storage device 740 and other components of content player 520.

### Example Embodiments

Example 1: In one example, a computer-implemented method includes receiving, as training data, streaming session data for a user profile in a streaming service, designating continue-watching behavior across a session pair of the user profile as a positive proxy signal, indicating that the same user is watching in both sessions of the session pair, designating concurrent viewing behavior between two or more sessions of the user profile as a negative proxy signal, indicating that different users are watching in the two or more sessions, using the positive and negative proxies to train a model to distinguish between streaming sessions belonging to the same or different users of the user profile, and deploying the trained model to infer one or more virtual user identifications within the streaming service, each virtual user identification representing an inferred user distinct from other inferred users.
Example 2: The method of Example 1, where designating continue-watching behavior between across the session pair of the user profile as a positive proxy signal includes detecting, within the streaming session data, the session pair as a session pair with same-title playback, where a second session of the session pair resumes playback of the same title previously played in a first session of the session pair at a start timestamp that is within a designated time window of the first session's stop timestamp, and labeling the session pair as a positive pair based on the detected continue-watching resumption.
Example 3: The method of any one or more of Examples 1-2, where designating concurrent viewing behavior between the two or more sessions of the user profile as a negative proxy signal includes detecting, within the additional streaming session data, a session pair with playback of different titles during overlapping time intervals under the user profile, and labeling the session pair as a negative pair based on the detected concurrent viewing.
Example 4: The method of any one or more of Examples 1-3, where the method further includes constructing session features from the streaming session data to use as inputs to train the model and the constructed session features include device indicators, location indicators, time features, content features, user interaction features, and/or recommendation context features.
Example 5: The method of any one or more of Examples 1-4, where features that are directly derived from continue-watching behavior or concurrent viewing behavior are excluded from the constructed session features.
Example 6: The method of any one or more of Examples 1-5, where the method further includes training the model with a contrastive objective that reduces a distance between positive session pairs and increases a distance between negative session pairs.
Example 7: The method of any one or more of Examples 1-6, where the method further includes training the model by enforcing a minimum separation margin for negative session pairs such that negative session pairs with a distance below the margin incur an increased loss.
Example 8: The method of any one or more of Examples 1-7, where during training the model is configured to increase a weight applied to negative session pairs relative to positive session pairs in a loss function /d/ or dynamically adjust positive and negative weights per training batch based on observed counts of positive and negative session pairs.
Example 9: The method of any one or more of Examples 1-8, where dynamically adjusting positive and negative weights per training batch includes setting, for each batch, a positive weight and a negative weight as functions of the counts of negative and positive session pairs in the batch, respectively, to maintain balanced learning.
Example 10: The method of any one or more of Examples 1-9, where the method further includes training the model by selecting hard negative session pairs having an embedding distance below a margin and increasing a sampling rate and/or a loss weight for the selected hard negative session pairs.
Example 11: The method of any one or more of Examples 1-10, where deploying the model to infer virtual user identifications within the streaming service includes, for each user profile within a set of user profiles, grouping streaming sessions into multiple virtual users based on distances between session-level embeddings.
Example 12: In one example, a system includes one or more processors and physical memory including computer-executable instructions that, when executed by a physical processor, cause the physical processor to receive, as training data, streaming session data for a user profile in a streaming service, designate continue-watching behavior across a session pair of the user profile as a positive proxy signal, indicating that the same user is watching in both sessions of the session pair, designate concurrent viewing behavior between two or more sessions of the user profile as a negative proxy signal, indicating that different users are watching in the two or more sessions, use the positive and negative proxies to train a model to distinguish between streaming sessions belonging to the same or different users of the user profile, and deploy the trained model to infer one or more virtual user identifications within the streaming service, where a virtual user identification is an identification of an inferred user distinct from other inferred users.
Example 13: The system of Example 12, where designating continue-watching behavior across the session pair of the user profile as a positive proxy signal includes detecting, within the streaming session data, the session pair as a session pair with same-title playback, where a second session of the session pair resumes playback of the same title previously played in a first session of the session pair at a start timestamp that is within a designated time window of the first session's stop timestamp, and labeling the session pair as a positive pair based on the detected continue-watching resumption.
Example 14: The system of any one or more of Examples 12-13, where designating concurrent viewing behavior between the two or more sessions of the user profile as a negative proxy signal includes detecting, within the streaming session data, an additional session pair with playback of different titles during overlapping time intervals under the user profile, and labeling the additional session pair as a negative pair based on the detected concurrent viewing.
Example 15: The system of Examples 12-14, where the computer-executable instructions further cause the physical processor to construct session features from the streaming session data to use as inputs to train the model, the constructed session features including device indicators, location indicators, time features, content features, user interaction features, and/or recommendation context features.
Example 16: The system of any one or more of Examples 12-15, where features that are directly derived from continue-watching behavior or concurrent viewing behavior are excluded from the constructed session features.
Example 17: The system of any one or more of Examples 12-16, where the computer-executable instructions further cause the physical processor to train the model with a contrastive objective that reduces a distance between positive session pairs and increases a distance between negative session pairs.
Example 18: The system of any one or more of Examples 12-17, where the computer-executable instructions further cause the physical processor to train the model by enforcing a minimum separation margin for negative session pairs such that negative session pairs with a distance below the margin incur an increased loss.
Example 19: The system of any one or more of Examples 12-18, where during training the model is configured to increase a weight applied to negative session pairs relative to positive session pairs in a loss function and/or dynamically adjust positive and negative weights per training batch based on observed counts of positive and negative session pairs.
Example 20: In one example, a non-transitory computer-readable medium includes one or more computer-executable instructions that, when executed by at least one processor of a computing device, cause the computing device to receive, as training data, streaming session data for a user profile in a streaming service, designate continue-watching behavior across a session pair of the user profile as a positive proxy signal, indicating that the same user is watching in both sessions of the session pair, designate concurrent viewing behavior between two or more sessions of the user profile as a negative proxy signal, indicating that different users are watching in the two or more sessions, use the positive and negative proxies to train a model to distinguish between streaming sessions belonging to the same user of the user profile or between different users of the user profile, and deploy the trained model to infer one or more virtual user identifications within the streaming service, were a virtual user identification represents an identification of an inferred user distinct from other inferred users.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, as training data, streaming session data for a user profile in a streaming service;
designating continue-watching behavior across a session pair of the user profile as a positive proxy signal, indicating that a same user is watching in both sessions of the session pair;
designating concurrent viewing behavior between two or more sessions of the user profile as a negative proxy signal, indicating that different users are watching in the two or more sessions;
using the positive and negative proxy signals to train a model to distinguish between streaming sessions belonging to the same user of the user profile or between different users of the user profile; and
deploying the trained model to infer at least one virtual user identification within the streaming service, the virtual user identification comprising an identification of an inferred user distinct from other inferred users.

2. The computer-implemented method of claim 1, wherein designating continue-watching behavior across the session pair as a positive proxy signal comprises:
detecting, within the streaming session data, the session pair as a session pair with same-title playback, where a second session of the session pair resumes playback of a same title previously played in a first session of the session pair at a start timestamp that is within a designated time window of a stop timestamp of the first session; and
labeling the session pair as a positive pair based on the detected same-title playback.

3. The computer-implemented method of claim 1, wherein designating concurrent viewing behavior between the two or more sessions of the user profile as a negative proxy signal comprises:
detecting, within the streaming session data, an additional session pair with playback of different titles during overlapping time intervals under the user profile; and
labeling the additional session pair as a negative pair based on the detected playback of different titles during the overlapping time intervals under the user profile.

4. The computer-implemented method of claim 1, further comprising constructing session features from the streaming session data to use as inputs to train the model, the constructed session features comprising at least one of device indicators, location indicators, time features, content features, user interaction features, or recommendation context features.

5. The computer-implemented method of claim 4, wherein features that are directly derived from continue-watching behavior or concurrent viewing behavior are excluded from the constructed session features.

6. The computer-implemented method of claim 1, further comprising training the model with a contrastive objective that reduces a distance between positive session pairs and increases a distance between negative session pairs.

7. The computer-implemented method of claim 1, further comprising training the model by enforcing a minimum separation margin for negative session pairs such that negative session pairs with a distance below the margin incur an increased loss.

8. The computer-implemented method of claim 1, wherein during training the model is configured to at least one of:
increase a weight applied to negative session pairs relative to positive session pairs in a loss function; or
dynamically adjust positive and negative weights per training batch based on observed counts of positive and negative session pairs.

9. The computer-implemented method of claim 8, wherein dynamically adjusting positive and negative weights per training batch comprises setting, for each batch, a positive weight and a negative weight as functions of the counts of negative and positive session pairs in the batch, respectively, to maintain balanced learning.

10. The computer-implemented method of claim 1, further comprising training the model by selecting hard negative session pairs having an embedding distance below a margin and increasing at least one of a sampling rate or a loss weight for the selected hard negative session pairs.

11. The computer-implemented method of claim 1, wherein deploying the model to infer the at least one virtual user identification within the streaming service comprises for each user profile within a plurality of user profiles, grouping streaming sessions into a plurality of virtual users based on distances between session-level embeddings.

12. A system comprising:
one or more processors; and
physical memory comprising computer-executable instructions that, when executed by a physical processor, cause the physical processor to:
receive, as training data, streaming session data for a user profile in a streaming service;
designate continue-watching behavior across a session pair of the user profile as a positive proxy signal, indicating that a same user is watching in both sessions of the session pair;
designate concurrent viewing behavior between two or more sessions of the user profile as a negative proxy signal, indicating that different users are watching in the two or more sessions;
use the positive and negative proxy signals to train a model to distinguish between streaming sessions belonging to the same user of the user profile or between different users of the user profile; and
deploy the trained model to infer at least one virtual user identification within the streaming service, the virtual user identification comprising an identification of an inferred user distinct from other inferred users.

13. The system of claim 12, wherein designating continue-watching behavior across the session pair of the user profile as a positive proxy signal comprises:
detecting, within the streaming session data, the session pair as a session pair with same-title playback, where a second session of the session pair resumes playback of a same title previously played in a first session of the session pair at a start timestamp that is within a designated time window of a stop timestamp of the first session; and
labeling the session pair as a positive pair based on the detected same-title playback.

14. The system of claim 12, wherein designating concurrent viewing behavior between the two or more sessions of the user profile as a negative proxy signal comprises:
detecting, within the streaming session data, an additional session pair with playback of different titles during overlapping time intervals under the user profile; and
labeling the additional session pair as a negative pair based on the detected playback of different titles during the overlapping time intervals under the user profile.

15. The system of claim 12, wherein the computer-executable instructions further cause the physical processor to construct session features from the streaming session data to use as inputs to train the model, the constructed session features comprising at least one of device indicators, location indicators, time features, content features, user interaction features, or recommendation context features.

16. The system of claim 15, wherein features that are directly derived from continue-watching behavior or concurrent viewing behavior are excluded from the constructed session features.

17. The system of claim 12, wherein the computer-executable instructions further cause the physical processor to train the model with a contrastive objective that reduces a distance between positive session pairs and increases a distance between negative session pairs.

18. The system of claim 12, wherein the computer-executable instructions further cause the physical processor to train the model by enforcing a minimum separation margin for negative session pairs such that negative session pairs with a distance below the margin incur an increased loss.

19. The system of claim 12, wherein during training the model is configured to at least one of:
increase a weight applied to negative session pairs relative to positive session pairs in a loss function; or
dynamically adjust positive and negative weights per training batch based on observed counts of positive and negative session pairs.

20. A non-transitory computer-readable medium comprising one or more computer-executable instructions that, when executed by at least one processor of a computing device, cause the computing device to:
receive, as training data, streaming session data for a user profile in a streaming service;
designate continue-watching behavior across a session pair of the user profile as a positive proxy signal, indicating that a same user is watching in both sessions of the session pair;
designate concurrent viewing behavior between two or more sessions of the user profile as a negative proxy signal, indicating that different users are watching in the two or more sessions;
use the positive and negative proxy signals to train a model to distinguish between streaming sessions belonging to the same user of the user profile or between different users of the user profile; and
deploy the trained model to infer at least one virtual user identification within the streaming service, the virtual user identification comprising an inferred user distinct from other inferred users.
